(19) United States
(12) Patent Application Publication
(10) Pub. No.: US 2014/0052807 A1
(43) Pub. Date: Feb. 20, 2014

(54) SERVER AND METHOD FOR CONTROLLING SHARING OF FANS

(71) Applicant: Hon Hai Precision Industry Co., Ltd., New Taipei (TW)

(72) Inventor: CHIEN-CHI LIN, New Taipei (TW)

(21) Appl. No.: 13/929,786

(22) Filed: Jun. 28, 2013

(30) Foreign Application Priority Data
Aug. 17, 2012 (TW) 101129828

(51) Int. Cl. H04L 12/24

(52) U.S. Cl. CPC H04L 41/04
USPC 709/208

(57) ABSTRACT

A method for controlling share of a fan group comprising a plurality of fans between multiple servers, each of which generating an identity (ID) for itself. The method further synchronizes IDs among the servers and inserts the ID of each of the servers in an ID table stored in each of the servers. A control server is selected from the servers according to the ID table and a predetermined rule. The method further obtains total fan revolutions of the servers and the control server controls fan revolutions of the fan group to be equal to the total fan revolutions.

### BACKGROUND

1. Technical Field

Embodiments of the present disclosure relate to fans control technology, and particularly to a server and a method for controlling sharing of fans in servers.

2. Description of Related Art

Proper power consumption management is extremely important in data centers, where servers may run non-stop all year along. Traditionally, servers share fans to lower power consumption. A fan control module (FCM) is often used to control and manage the fans shared by the servers. However, the FCM itself consumes electricity, and designing the FCM increases hardware cost. Furthermore, a number of the servers that can share the fans may be restricted by hardware conditions of the FCM itself. Therefore, a more efficient way of sharing the fans is desired.

### BRIEF DESCRIPTION OF THE DRAWINGS

FIG. 1 is a schematic diagram of one embodiment of servers.

FIG. 2 is a block diagram of one embodiment of function modules of a control system in the each of the servers in FIG. 1.

FIG. 3 is a flowchart illustrating one embodiment of a method for controlling sharing of fans.

FIG. 4 is a flowchart illustrating one embodiment of a method for processing fault tolerance.

FIG. 5 is a schematic diagram of one embodiment of an ID table.

FIG. 6 is a schematic diagram of one embodiment of an ID table including an abnormal server.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

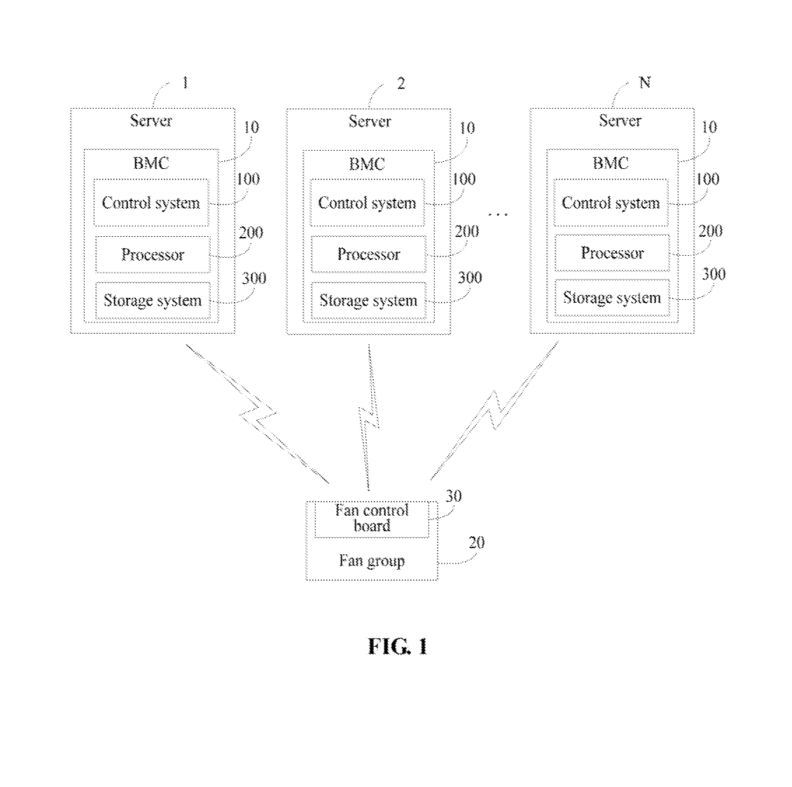

FIG. 1 is a block diagram of one embodiment of servers. The servers include a server 1, a server 2, a server 3 . . . and a server N. The servers 1 to N share a fan group 20 including a plurality of fans. The fan group 20 includes a fan control board 30 that controls the fans.

Each of the servers includes a baseboard management controller (BMC) 10. The BMC 10 can monitor different statuses (e.g. temperature, cooling fan speeds, power, or operating system (OS) status) of each of the servers, and communicate with other devices (e.g. other servers) or system administrator of the servers through a network (e.g. an Internet or an intranet). The BMC 10 includes a control system 100, at least one processor 200 and a storage system 300. The control system 100 controls fan revolutions of the fan group 20 via a determined control server. The control system 100 further reselects one of the other normal servers to be a new control server when the control server is abnormal.

The at least one processor 200 can execute one or more computerized codes and other applications for each of the servers 1 to N to provide the functions of the control system 100. The storage system 300 stores the one or more computerized codes of the control system 100. In one embodiment, the storage system 300 may be a memory of the electronic device 1, or an external storage card, such as a smart media card, or a secure digital card.

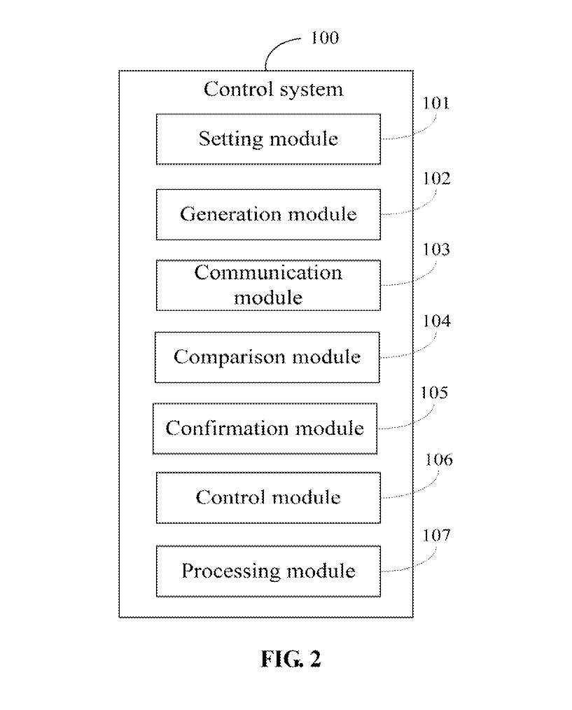

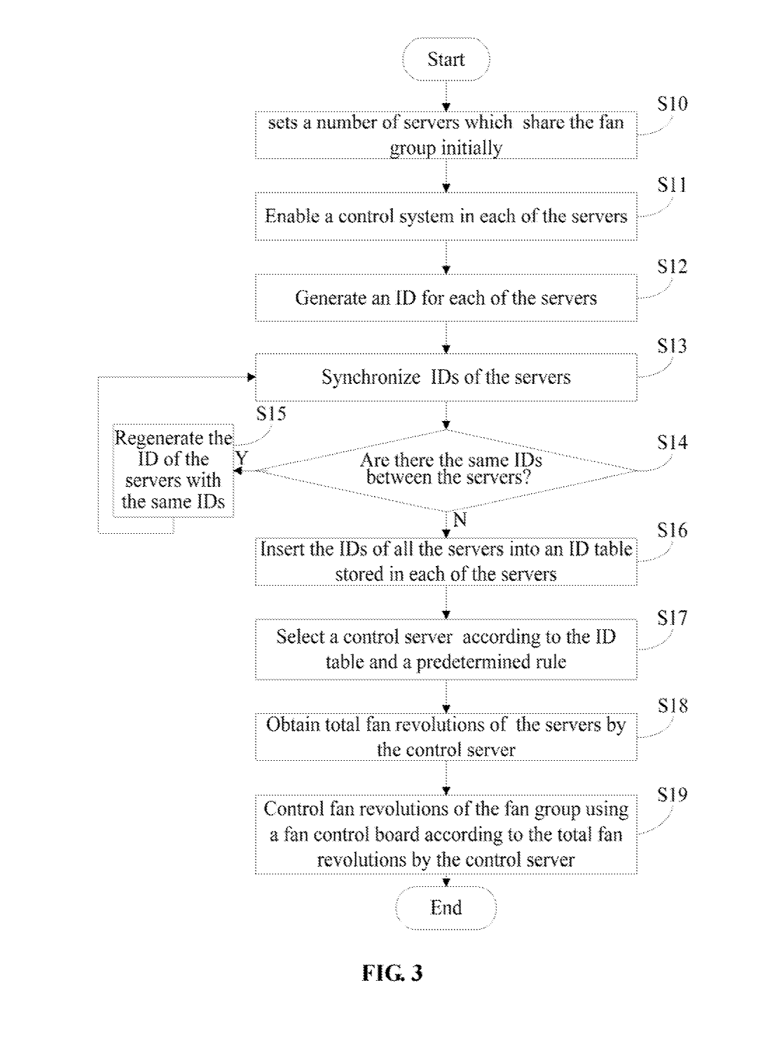

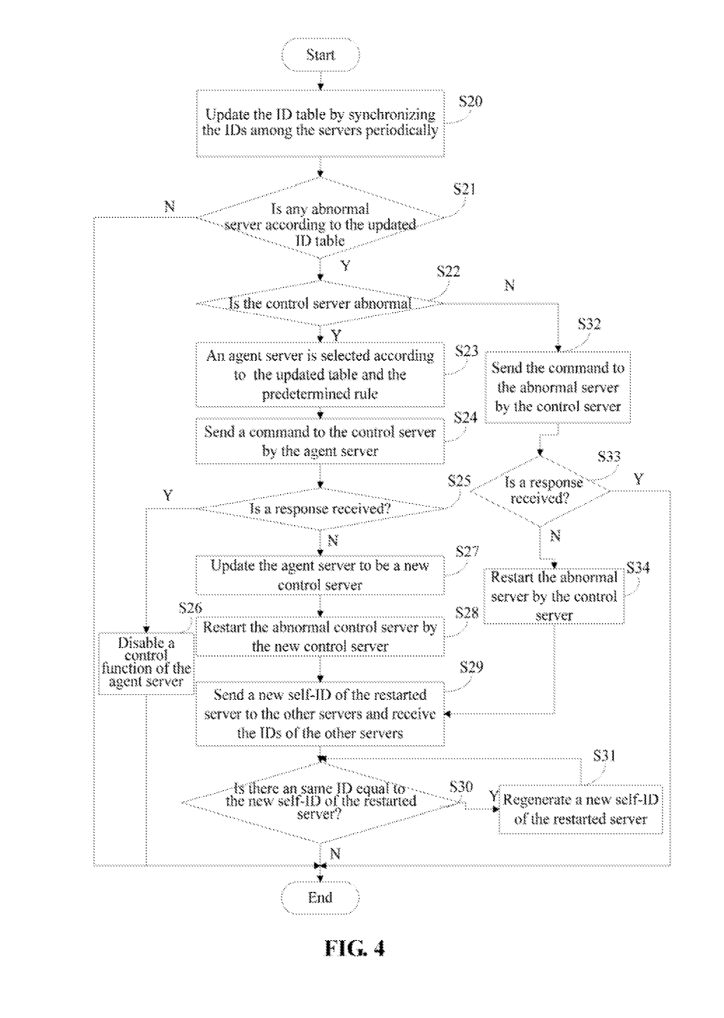

FIG. 2 is a block diagram of one embodiment of the control system 100 in each of the servers 1 to N. The control system 100 includes a setting module 101, a generation module 102, a communication module 103, a comparison module 104, a confirmation module 105, a control module 106 and a processing module 107. The modules 100-107 may comprise computerized instructions in the form of one or more programs stored in the storage system 300 and executed by the processor 200 to provide functions of the modules 100-107. FIG. 3 and FIG. 4 give the details of the modules 100-107.

FIG. 3 is a flowchart illustrating one embodiment of a method of controlling fan sharing. Depending on the embodiment, additional steps may be added, others deleted, and the ordering of the steps may be changed. In some embodiments, the control system 100 is running in each of the servers 1 to N.

In step S10, the setting module 101 sets an initial number of servers that share the fan group 20. For example, if the control system 100 needs to be installed in servers 1 to N for sharing the fan group 20, the setting module 101 sets the number of the servers to be “N” (e.g., 8). The number can be set according to actual requirements.

In step S11, the control system 100 in the servers 1 to N are enabled.

In step S12, the generation module 102 in each of the servers 1 to N generates an identity (ID) for each of the servers 1 to N automatically. For example, the generation module 102 in the server 1 generates the ID of the server 1 (e.g. ID=3) randomly, and the generation module 102 in the server 2 generates the ID of the server 2 (e.g. ID=5), and so on.

In step S13, the communication module 103 in each of the servers 1 to N synchronizes IDs of the servers by transmitting the self-ID of each of the servers to the other N−1 servers, and receiving other IDs from the other N−1 servers.

In step S14, the comparison module 104 in each of the servers 1 to N compares the self-ID and the other IDs, and determines whether any ID in the other IDs is equal to the self-ID.

In step S15, the generation module 102 in the each of the servers 1 to N regenerates another ID if there is one or more IDs in the other IDs being equal to the self-ID. For example, if the comparison module 103 in the server 1 determines that the ID of the server 3 is equal to the ID of the server 1, the generation module 102 in the server 1 regenerates an ID for the server 1. Furthermore, the generation module 102 in the server 3 also regenerates an ID for the server 3.

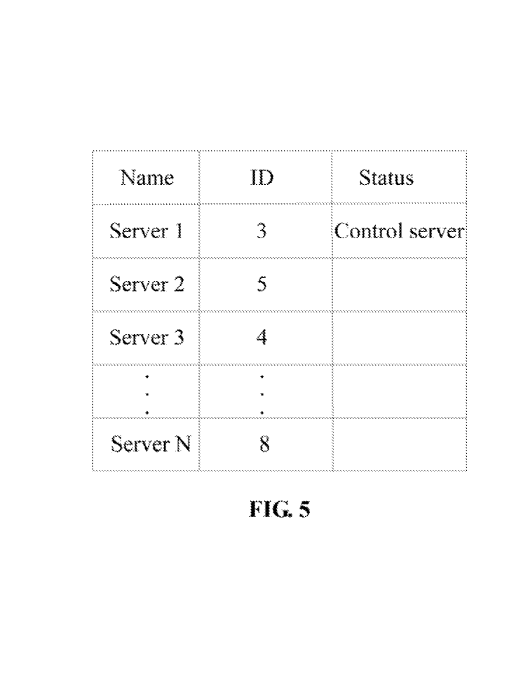

In step S16, the generation module 102 in the each of the servers 1 to N inserts the self-ID and the other IDs into an ID table stored in the storage system 300 of each of the servers 1 to N, if all the IDs of the servers 1 to N are different. As shown in FIG. 5, the ID table may include, but is not limited to, a name and the ID of each of the servers 1 to N.

In step S17, the confirmation module 105 in each of the servers 1 to N selects one of the servers 1 to N to be a control server, according to the ID table and a predetermined rule. In one embodiment, the predetermined rule may select a server having a minimum ID (if the ID is a number) or a server having a maximum ID (if the ID is a number) to be the control server. The confirmation module 105 compares the self-ID of each of the servers 1 to N to the other IDs in the ID table, and confirms the control server according to the predetermined rule. For example, as shown in FIG. 5, if the predetermined rule selects a server having a minimum ID number to be the control server, the server 1 having the ID of 3 is confirmed to be the control server, and a status of the server 1 is marked with “control server.”

In step S18, a control module 106 in the control server obtains a total fan revolutions of the servers 1 to N. In one embodiment, the control server sends a preset command of sending a required fan revolutions to the other N−1 servers, and the other N−1 servers sends the required fan revolutions to the control server.

In step S19, the control module 106 in the control server controls fan revolutions of the fan group 20 to be the total fan revolutions using the fan control board 30.

In other embodiments, in the method of the control sharing of fans, the processing module 107 may determine whether there is an abnormal server according to the ID table. If the abnormal server is the control server, a new control server is selected according to the ID table and the predetermined rule, and the abnormal server is restarted. FIG. 4 shows the processing module's detailed functions.

FIG. 4 is a flowchart illustrating one embodiment of a method for processing fault tolerance. Depending on the embodiment, additional steps may be added, others deleted, and the ordering of the steps may be changed.

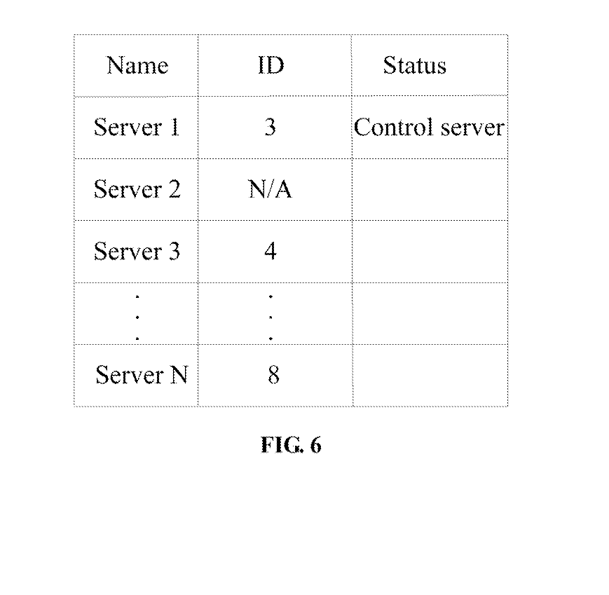

In step S20, the processing module 107 in each of the servers 1 to N updates the ID table by synchronizing the IDs among the servers 1 to N periodically. In some embodiments, if one of the servers 1 to N works normally, the ID of the server is not changed. Therefore, if all of the servers 1 to N work normally, the updated ID table is the same as a previous ID table (e.g., the ID table as mentioned above). If one of the servers 1 to N works abnormally, such as crashing or disconnecting, the abnormal server cannot transmit the ID of itself to the other N−1 servers. Therefore, the ID table in the other N−1 servers does not include the ID of an abnormal server, the ID of the abnormal server is blank without any data, such as displaying the ID as “N/A.” For example, as shown in FIG. 6, the ID of the abnormal server named “server 2” displays “N/A.”

In step S21, the processing module 107 in each of the servers 1 to N determines whether there is an abnormal server according to the updated ID table. If the ID of one server is blank or displays “N/A,” the processing module 107 determines that such server is an abnormal server. If there is no abnormal server, the procedure ends. If there is an abnormal server, step S22 is implemented.

In step S22, the processing module 107 further determines whether the abnormal server is the control server. If the abnormal server is the control server, step S23 is implemented. If the abnormal server is not the control server, step S32 is implemented.

In step S23, the processing module 107 selects an agent server from the one of the normal servers in the ID table according to the predetermined rule. The agent server has a control function that can control other servers.

In step S24, the processing module 107 in the agent server sends a command to the control server. The command may be a command of transmitting the ID of the abnormal server to the agent server or a request command that asks the control server to send an answer to the agent server, for example.

In step S25, the processing module 107 in the agent server determines whether a response has been received from the control server in a predetermined time duration.

In step S26, if the response has been received from the control server, a control function of the agent server is disabled and the control server is determined to be normal, and the procedure ends. The status of the control server is maintained.

In step S27, if no response has been received from the control server, the agent server is updated to be a new control server. A status of the agent server becomes “control server” and the status of the previous control server is deleted. That is, the previous control server has been found to be abnormal.

In step S28, the processing module 107 in the new control server restarts the abnormal server.

In step S29, the communication module 103 in the restarted abnormal server transmits a new self-ID to the other servers, and receives other IDs transmitted by the other servers.

In step S30, the comparison module 104 in the restarted abnormal server compares the new self-ID with the other IDs, and determines whether there is a same ID in the other IDs equal to the new self-ID. If there is no same ID in the other IDs, the procedure ends.

In step S31, the generation module 102 in the restarted abnormal server regenerates a further new self-ID for the restarted abnormal server if a same ID is discovered in the other IDs, and step 30 is repeated.

In step 32, the processing module 107 in the control server sends the command to the abnormal server. For example, the command also may be the command of transmitting the ID of the abnormal server to the control server or the request command that asks the abnormal server to send an answer to the control server.

In step S33, the processing module 107 in the control server determines whether a response has been received from the abnormal server in the predetermined time duration. If the response is received from the abnormal server, the procedure ends.

In step S34, if no response has not been received from the abnormal server, the processing module 107 in the control server restarts the abnormal server, and step S29 is implemented.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method for controlling share of a fan group between servers, the fan group comprising a plurality of fans, the method comprising:
(a) generating an identity (ID) of each of the servers;
(b) synchronizing IDs among the servers and inserting the ID of each of the servers in an ID table stored in each of the servers;
(c) selecting a control server from the servers according to the ID table and a predetermined rule;
(d) obtaining total fan revolutions of the servers and controlling fan revolutions of the fan group to be equal to the total fan revolutions by the control server.

2. The method as described in claim 1, before the step (a), further comprising:
setting a number of the servers which share the fan group.

3. The method as claimed in claim 1, wherein step (b) comprises:
comparing the IDs of the servers to determine whether there are same IDs among the servers; and
regenerating new IDs for servers which have the same IDs, when there are the same IDs.

4. The method as claimed in claim 1, further comprising:
updating the ID table by synchronizing the IDs among each of the servers periodically;
determining whether there is an abnormal server according to the updated ID table; and
when the abnormal server is the control server, selecting a new control server from one of normal servers in the updated ID table according to the predetermined rule, and controlling the abnormal server to be restarted by the new control server; or
when the abnormal server is not the control server, controlling the abnormal server to be restarted by the control server.

5. The method as claimed in claim 4, wherein the ID of the abnormal server is blank in the updated ID table.

6. The method as claimed in claim 1, wherein the predetermined rule is to select one server having the minimum ID among the servers to be the control server.

7. A Baseboard Management Controller (BMC) in each of servers, comprising:
at least one processor; and
a computer-readable storage medium storing one or more programs, which when executed by the at least one processor, causes the at least one processor to:
generate an identity (ID) of each of the servers;
synchronize IDs among the servers and insert the ID of each of the servers in an ID table stored in each of the servers;
select a control server from the servers according to the ID table and a predetermined rule;
obtain total fan revolutions of the servers and control fan revolutions of the fan group to be equal to the total fan revolutions by the control server.

8. The BMC as described in claim 7, wherein the one or more programs further cause the at least one processor to set a number of the servers which share the fan group initially.

9. The BMC as described in claim 7, wherein the one or more programs further cause the at least one processor to compare the IDs of the servers to determine whether there are same IDs among the servers; and
regenerate new IDs for the servers that which have the same IDs, when there are the same IDs.

10. The BMC as described in claim 7, wherein the one or more programs further cause the at least one process to update the ID table by synchronizing the IDs among each of the servers periodically;
determine whether there is an abnormal server according to the updated ID table;
when the abnormal server is the control server, select a new control server from one of normal servers in the updated ID table and according to the predetermined rule, and control the abnormal server to be restarted by the new control server; or
when the abnormal server is not the control server, control the abnormal server to be restarted by the control server.

11. The BMC as claimed in claim 10, wherein the ID of the abnormal server is blank in the updated ID table.

12. The method as claimed in claim 7, wherein the predetermined rule is to select one server having the minimum ID among the servers to be the control server.

13. A non-transitory computer readable storage medium having stored thereon instructions that, when executed by a processor of an electronic device, causes the electronic device to perform a method for controlling share of a fan group between servers, the method comprising:
(a) generating an identity (ID) of each of the servers;
(b) synchronizing IDs among the servers and inserting the ID of each of the servers in an ID table stored in each of the servers;
(c) selecting a control server from the servers according to the ID table and a predetermined rule;
(d) obtaining total fan revolutions of the servers and controlling fan revolutions of the fan group to be equal to the total fan revolutions by the control server.

14. The non-transitory computer readable storage medium as described in claim 13, before the step (a), further comprising:
setting a number of the servers which share the fan group.

15. The non-transitory computer readable storage medium as described in claim 13, wherein step (b) comprises:
comparing the IDs of the servers to determine whether there are same IDs among the servers; and
regenerating new IDs for servers that which have the same IDs, when there are the same IDs.

16. The non-transitory computer readable storage medium as described in claim 13, further comprising:
updating the ID table by synchronizing the IDs among the servers periodically;
determining whether there is an abnormal server according to the updated ID table; and
when the abnormal server is the control server, selecting a new control server from one of normal servers in the updated ID table according to the predetermined rule, and controlling the abnormal server to be restarted by the new control server; or
when the abnormal server is not the control server, controlling the abnormal server to be restarted by the control server.

17. The non-transitory computer readable storage medium as described in claim 16, wherein the ID of the abnormal server is blank in the updated ID table.

18. The non-transitory computer readable storage medium as described in claim 13, wherein the predetermined rule is to select one server having the minimum ID among the servers to be the control server.
